(19) United States
(12) Patent Application Publication
(10) Pub. No.: US 2022/0152874 A1
(43) Pub. Date: May 19, 2022

(54) TWIN-SCREW MIXING AND EXTRUSION MACHINE WITH MOBILE ELEMENTS

(71) Applicant: COMPAGNIE GENERALE DES ETABLISSEMENTS MICHELIN, Clermont-Ferrand (FR)

(72) Inventors: BRUNO DUSSARDIER, Clermont-Ferrand (FR); AURELIEN TOURNEBIZE, Clermont-Ferrand (FR)

(21) Appl. No.: 17/436,371

(22) PCT Filed: Jan. 28, 2020
(86) PCT No.: PCT/EP2020/052033

§ 371 Date: Sep. 3, 2021

(30) Foreign Application Priority Data
Mar. 6, 2019 (FR) 1902279

(51) Int. Cl. B29B 7/20; B29C 48/40; B29C 48/525; B29B 7/18; B29B 7/26; B29B 7/74; B29B 7/80

(52) U.S. Cl. CPC B29B 7/20; B29C 48/402; B29C 48/525; B29B 7/802; B29B 7/26; B29B 7/7495; B29B 7/183

(57) ABSTRACT

A mixing and extrusion machine (10) has a converging conical twin-screw mixer (12) with a fixed frame (14) that supports sleeves (16) in which two screws (18) are mounted at an angle between an opening (22) arranged upstream of the sleeves, where an introduction hopper (24) of the machine (10) feeds the screws, and an outlet (25) arranged downstream of the sleeves, where the mixer discharges the mixture at the end of a mixing cycle. At least one mobile sleeve (34) is disposed towards the outlet, each mobile sleeve with a support surface (34a) of a predetermined surface area (34a) according to an elasticity of the mixture, and each mobile sleeve having one or more mobile elements that move by a linear movement with respect to the outlet in order to adjust a predetermined space between the sleeves and the screws.

### TECHNICAL FIELD

The invention is directed to mixers used in the field of producing rubber mixtures. More particularly, the invention is directed to mechanisms to promote the flow of a mixture inside a mixer.

### BACKGROUND

In the field of producing rubber mixtures, twin screw extruders already exist, each having a chassis with common assembled parts. The assembled parts may include, without limitation, a sheath screw assembly (with or without its optional heating and cooling accessories), a drive unit (gearbox and coupling), a main motor, devices for supplying material (for example, dosers or hoppers) or for its treatment (for example, degassing devices), a cutting or shaping device for the extruded material, if applicable, a control cabinet that connects the motor drives, start and safety devices, and control, command, display and measurement devices.

There are examples of twin-screw extruders described in the publication “Extrusion—Twin-Screw Extrusion Processes” by Bruno Vergnes and Marc Chapet, published on Jan. 10, 2001 by Techniques de l'Ingénieur, traitéPlastiques et Composites (“the Vergnes/Chapet reference”).

The chassis often includes a manual or assisted sleeve opening device, allowing easy access to the screws for cleaning, inspection and/or maintenance. The most commonly used opening system consists of a slide that slides the sleeve relative to the screws (for example, of the type offered commercially by Colmec and Pomini TDE). There are also “portfolio” opening systems, where the sheath is articulated around a lateral hinge (typically known as the Farrel continuous mixer, or “FCM”). The sleeve screw assembly is the active part and ensures the treatment of the material. The sheath is the outer envelope. The sleeve is temperature regulated by the combination of a heating system, generally electric, controlled by temperature control probes, with a cooling system, usually with water circulation. Inside the sleeve, the two rotating screws consume the material and move it forward.

The screw mixing and extrusion machines that are usually used are made up of rotors (i. e., the screw(s)) and stators (i. e., the sleeves). Such a machine is described by the publication WO2005039847 which represents an example of a converging conical twin-screw machine with a movable door that closes the outlet. This type of mixer allows the combination of a mixing phase of the raw materials and an evacuation phase of the mixture thanks to a movable door at the exit (this movable door being arranged at the end of the screw). The removable door is closed and locked during the mixing cycle, preventing the mixture from exiting the machine. When the mixing cycle is complete, the removable door is unlocked and opens. The rotating screws can then bring forward the product contained inside the machine.

This phenomenon of internal movement of the product inside a mixing and extrusion machine is only possible when the viscosity of the product is not too high, such as for thermoplastic materials such as silicone and for some rubber materials. If the viscosity is too high, the pressures necessary to create the flows are not reached by the machine, and the mixing is difficult. At the beginning of the cycle, when the materials are cold, the flows of the mixtures are not immediate. Thus, it takes several tens of seconds for the product to warm up, causing a decrease in viscosity, to obtain the optimized mixing flows as described in publication WO2005039847.

The use of mobile sleeves on mixing and extrusion machines is also known. In the past, mobile sleeves have been designed to vary in real time the internal clearances and volumes inside the mixing and extrusion machines having screws and sleeves (see the examples disclosed in publications WO2009057753 and JPH0550425). The product to be extruded or mixed passes through the spaces left by the difference in volume between the screw and the sleeves. These spaces, and more particularly the clearance left between the crest of the screw threads and the crest of the sleeve threads (if the sleeve has no threads, the smallest inside diameter is considered), are important for working the product, its forward speed and any pressure inside the machine. The quality of mixing or extrusion is related to these internal clearances.

Thus, the disclosed invention combines the benefits of converging conical twin-screw mixers with the benefits of mobile sleeves. By combining these solutions, improved mixing is achieved reliably and in shorter cycle times. This type of mixer can be equipped with a roller nose system at the outlet that will allow the product to be discharged in the form of a sheet.

### SUMMARY

The invention concerns a mixing and extrusion machine for the production of rubber mixtures. The machine includes a mixer with a converging conical twin screw with a fixed frame that supports sleeves in which two screws are mounted at an angle between an opening arranged upstream of the sleeves, where an introduction hopper of the machine feeds the screws, and an outlet arranged downstream of the sleeves, where the mixer discharges the mixture at the end of a mixing cycle, one or more motors that rotate the two screws in the sleeves during the mixing cycle, and one or more removable doors provided at the outlet to allow, during the mixing cycle, the discharge and shaping of a rubber mixture. At least one mobile sleeve is disposed towards the outlet, each mobile sleeve with a support surface of a predetermined surface area according to an elasticity of the mixture, and each mobile sleeve having one or more mobile elements that move linearly with respect to the outlet in order to adjust a predetermined space between the sleeves and the screws. Linear motion is defined between a closed position of a mobile sleeve to facilitate mixing of the mixture, and an open position of a mobile sleeve to facilitate the flow of the mixture inside the mixer.

In some embodiments of the machine, at least two mobile sleeves are arranged towards the exit. In some embodiments, the mobile sleeves are arranged top-down towards the outlet. In some embodiments, the linear movement of the mobile sleeves is chosen from simultaneous movement, reciprocating movement and random movement of the mobile elements.

In some embodiments of the machine, the machine further includes a ram with an inner surface having a shape that is complementary to an outer contour of the two screws, the ram moving inside the introduction hopper between a raised position, where the two screws remain accessible for introducing the mixture, and a lowered position, where the inner surface of the ram forms an upper part of the mixer.

In some embodiments of the machine, the machine also includes a roller nose system with two counter-rotating rollers arranged just downstream of the outlet to form a sheet of the mixture discharged from the mixer.

In some embodiments of the machine, the screws are mounted in the mixer so that the crests of each screw thread come into tangential contact with the surfaces of the opposite screw so that the screws remain substantially in contact with each other when rotating the screws at an angle and at a center distance that allows self-cleaning. In some embodiments, the screws are selected from interpenetrated and conjugated profiles, including interpenetrated co-rotative profiles with conjugated profiles.

The invention also concerns a mixing process of the type including a step of mixing and extruding a mixture from the disclosed machine. The process includes the following steps:

a step of rotating the screws forward with the removable door closed;

a step of introducing the mixture to the machine, during which the screws continue to rotate and the removable door remains closed; and

a machine emptying step, during which the removable door opens to discharge the mixture from the machine outlet toward a downstream process, and during which the screws continue to rotate until the mixer is empty.

In some embodiments of the process, the step of introducing the mixture to the machine mixing includes the introduction of raw materials to form the mixture.

In some embodiments of the process, the step of introducing the mixture to the machine includes the introduction of one or more masterbatches.

In some embodiments of the process, the removable door is in the closed position at the beginning of the mixing cycle and in the open position at the end of the mixing cycle; and each mobile sleeve is in the open position at the beginning of the mixing cycle and in the closed position at the end of the mixing cycle.

Other aspects of the invention will become evident through the following detailed description.

### BRIEF DESCRIPTION OF THE DRAWINGS

The nature and various advantages of the invention will become more obvious when reading the following detailed description, in conjunction with the attached drawings, in which the same reference numbers refer everywhere to identical elements, and in which:

FIG. 1 shows a perspective view of a mixing and extrusion machine of the invention.

FIG. 2 shows a lateral view, in partial section, of an embodiment of the machine of FIG. 1 with a converging conical twin-screw mixer.

FIG. 3 shows a top view, in partial section, of an embodiment of the mixer of FIG. 2 with a mobile sleeve arranged towards an outlet where the mixer discharges the mixture at the end of the mixing cycle.

FIG. 4 shows a partial cross-sectional side view of the mixer of FIG. 3 with the mobile sleeve in the open position, and FIG. 5 shows a corresponding view with the mobile sleeve in the closed position.

FIG. 6 shows a perspective view of another embodiment of the mixer of FIG. 2 with two mobile sleeves arranged towards an outlet where the mixer discharges the mixture at the end of the mixing cycle.

FIG. 7 shows a partial cross-sectional side view of the mixer of FIG. 6 with the mobile sleeves in the open position, and FIG. 8 shows a corresponding view with the mobile sleeves in the closed position.

FIG. 9 shows a lateral view, in partial section, of another embodiment of the machine of FIG. 1.

FIG. 10 shows a front view of a ram of the machine of FIG. 9.

FIG. 11 shows a partial cross-sectional lateral view of the ram of FIG. 10 in a lowered position relative to the mixer.

### DETAILED DESCRIPTION

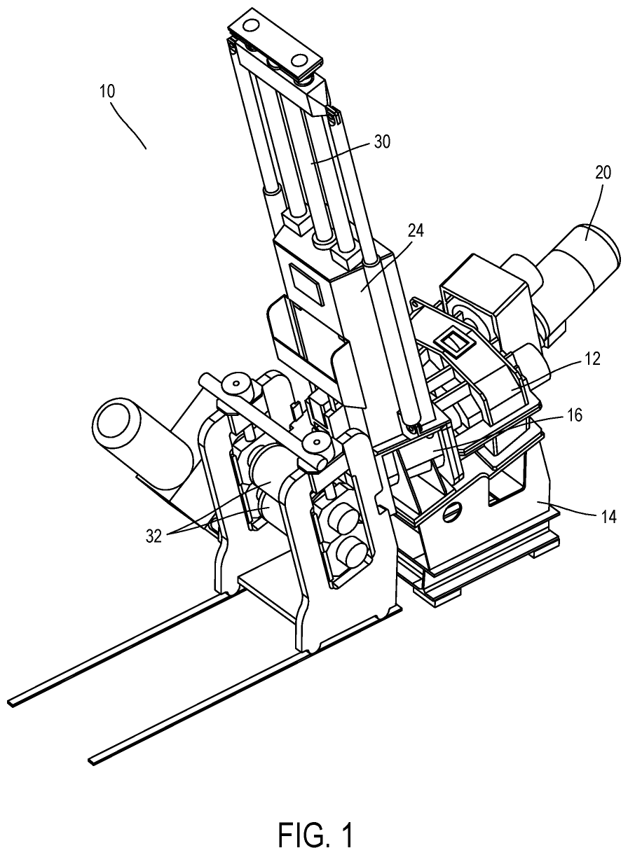

Referring now to the figures, in which the same numbers identify identical elements, FIG. 1 represents an embodiment of a mixing and extrusion machine (or “machine”) 10 of the invention. The machine 10 includes a converging conical twin-screw mixer (or “mixer”) 12 suitable for rubber materials. The mixer 12 includes a fixed frame 14 that supports fixed sleeves (or “sleeves”) 16 in which the two screws 18 are mounted. One or more motors 20 rotate the two screws in the sleeves 16 during a mixing cycle. An upper surface of the fixed frame 14 includes guides (not shown) on which the sleeves 16 (without screws 18) are able to move in a translational movement. The mixer 12 is chosen from commercially available mixers, including those of the type disclosed by the U.S. Pat. No. 7,556,419 and proposed by Colmec S.p.A. In an embodiment, this type of mixer effects mixing and discharge with Archimedes screw type screws.

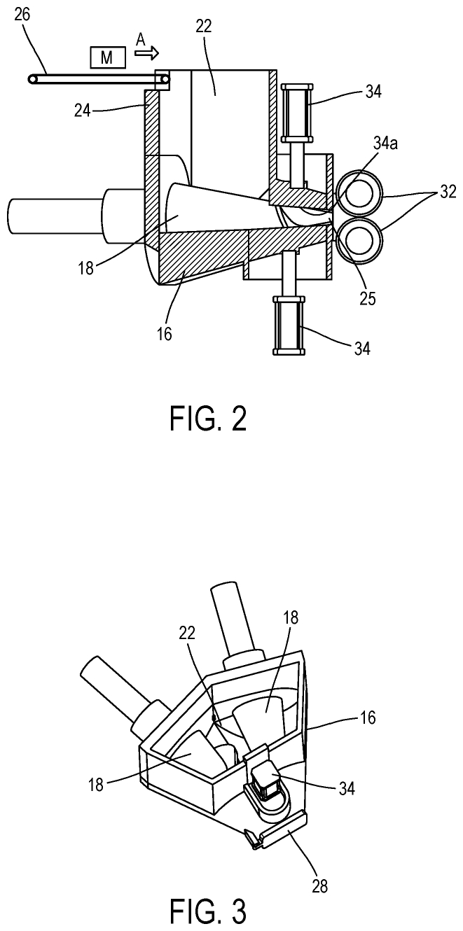

Referring further to FIG. 1 and also to FIG. 2 (which represents an embodiment of the machine of FIG. 1), the screws 18 are mounted in the sleeves 16 at an angle between an opening 22 arranged upstream of the sleeves (where an introduction hopper 24 of the machine 10 feeds the screws 18), and an outlet 25 arranged downstream of the sleeves (where the mixer 12 discharges the mixture at the end of the mixing cycle). The sleeves 16 can include cooling channels that are known to manage the temperature of the mixture. The contour of an inner surface of the sleeves 16 is predefined, which makes it possible to determine a distance between each thread and the inner surface of a corresponding sleeve, and thus the shear rate at the inner surface of the sheaths. In some embodiments of the mixer 12, the screw threads contact tangentially the inner surfaces of the sleeves, preventing any retention of mixing material on these surfaces.

The machine 10 can include an optional conveyor known to the skilled person (for example, the belt 26 shown in FIG. 2) to be used to introduce components through an introduction hopper 24. The components are represented by the mixture M being transported by the belt 26 (see arrow A in FIG. 2). These components can be all of the types of components necessary for the manufacture of rubber products. During a mixing cycle, the belt 26 (or other equivalent means) is used to successively introduce the raw materials and other necessary ingredients according to a predetermined recipe.

Referring further to FIGS. 1 and 2 and also to FIGS. 3 to 5, at least one mobile door 28 is provided at the outlet 25 of the sleeves 16 that closes the outlet during the mixing cycle (as used here, the terms “mobile door” and “mobile doors” are interchangeable). The mobile door 28 can be one or more mobile elements, including sliding shutters, that can move in an alternative or random manner in order to adjust the flow of the mixture discharged from the mixer 12.

The mobile door 28 is installed with respect to the mixer outlet 25 so that, in a closed position, it prevents the mixture from exiting the mixer 12 (for example, to promote mixing when the mixture has a lower viscosity). At the end of the mixing cycle, the mobile door 28 is opened so that the rubber mixture can be evacuated and shaped. The machine 10 can allow partial or complete opening of the mobile door so as to allow part or all of the mixture to be extruded.

Referring again to FIGS. 3 to 5, the machine 10 combines the benefits of the screws 18 with a mobile sleeve 34 that is arranged towards the outlet 25. The mobile sleeve 34 includes a mobile element in order to adjust a predetermined space between the sleeves 16 and the screws 18. The mobile sleeve 34 has a support surface 34a with a predetermined surface area depending on the elasticity of the mixture. Mobile sleeves with different surface areas can be interchangeable to ensure the use of the machine without having to replace it.

The mobile sleeve 34 adjusts the space between the sleeves and screws to facilitate the flow of the mixture inside the mixer 12, thus allowing the duration and degree of mixing of the mixture to be adjusted. In FIGS. 3 to 5, the mobile sleeve 34 is shown above the outlet 25. It is well understood that the mobile sleeve can be placed below the outlet. It is also understood that other known mobile sleeve embodiments can be used (e. g., left, right and angled embodiments).

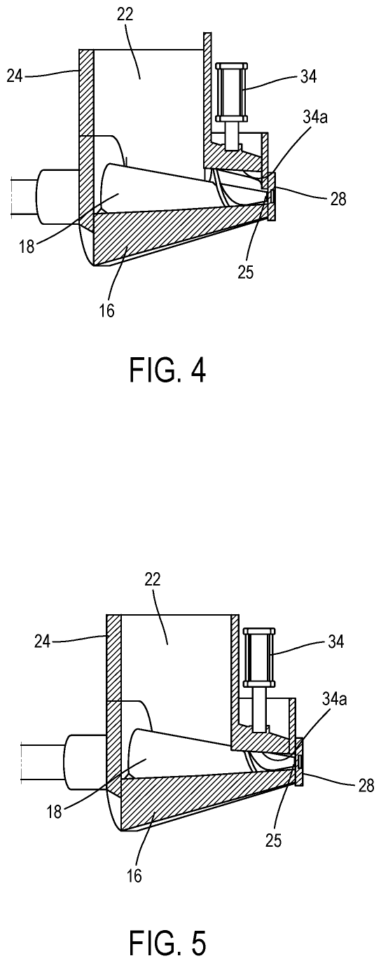

The two screws 18 circulate the mixture from an upstream side (next to the introduction hopper 24) to a downstream side where the sleeves 16 of the machine 10 are installed. The mobile sleeve 34 is installed in relation to the outlet 25 of the mixer 12 so that, in an open position, it allows the mixture to circulate. The mobile sleeve can move continuously or intermittently to reduce the space between the screws and the bearing surface in a corresponding manner, thus creating downstream-to-upstream mixing flows. For example, in a manner of using the machine 10, the mobile sleeve 34 is mostly in the open position at the beginning of the mixing cycle when the mixture has a high viscosity (to promote the mixing flow) (see FIG. 4). The mobile sleeve 34 is mostly in the closed position at the end of the mixing cycle when the mixture has a lower viscosity (to promote mixing) (see FIG. 5). The guidance of the mobile sleeve 34 is done by one or more known systems (driven, for example, by one or more cylinders that can be pneumatic, hydraulic or their equivalents). The linear movement of the mobile sleeve 34 can be controlled by the quantity and/or quality of the mixture generated by the mixer 12 (detected, for example, by a proximity sensor, by a pressure sensor, by a temperature sensor and/or by an equivalent device).

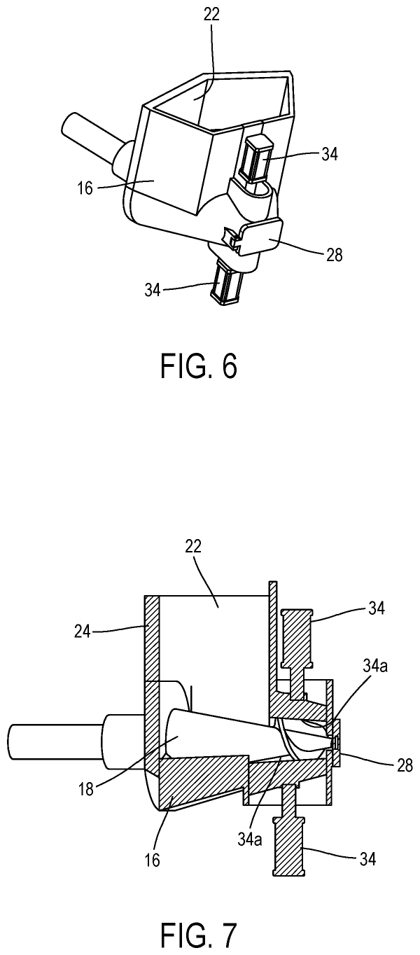

In addition, with reference to FIGS. 6 to 8, another embodiment of the mixer 12 of the machine 10 includes two mobile sleeves 34 as described with respect to FIGS. 3 to 5. The mobile sleeves 34 can be placed top-down towards the outlet 25. During a mixing cycle of the machine 10, the two screws 18 circulate the mixture from an upstream side (next to the introduction hopper 24) to a downstream side where the mobile sleeves 34 of the machine 10 are installed. Thus, the mobile sleeves 34 adjust the space between the mobile sleeves and the screws in such a way as to favor the flow of the mixture inside the mixer 12.

In the embodiments of the machine 10 including the mobile sleeves 34, the linear movement of the mobile sleeves 34 is selected from simultaneous movement, reciprocating movement and random movement of the mobile elements. The mobile sleeves 34 can move in an alternative or random manner to reduce the space between the screws 18 and the bearing surfaces 34a in a random manner, thus creating downstream-to-upstream mixing flows and preferably above or below. For example, in a manner of using the machine 10, the two mobile sleeves 34 are mostly in the open position at the beginning of the mixing cycle when the mixture has a high viscosity (to promote the mixing flow) (see FIG. 7). They are mostly in the closed position at the end of the mixing cycle when the mixture has a lower viscosity (to promote mixing) (see FIG. 8).

The design shown in FIGS. 6 to 8 includes two mobile sleeves 34. It is understood that several mobile sleeves (or other equivalent elements) can be integrated (for example, in top-down mode, left-right mode or angle mode).

The use of one or more mobile sleeves allows, from the beginning of the mixing cycle, to have a large air gap and therefore a low pressure drop despite a high viscosity. The product to be extruded or mixed passes through the spaces left by the difference in volume between the screw and its sleeves. These spaces, and more particularly the clearance left between the top of the screw threads and the top of the sleeve threads (if the sleeve has no threads, the smallest inside diameter is considered), are important for working the product, for its forward speed and for any pressure inside the machine. The product that is subjected to a very high pressure at the end of the screw will seek to move to areas where the pressure is lower. When the product moves through the machine, it will undergo significant shearing, which will promote the work and homogenization of the product. The product can be worked as from the beginning of the cycle.

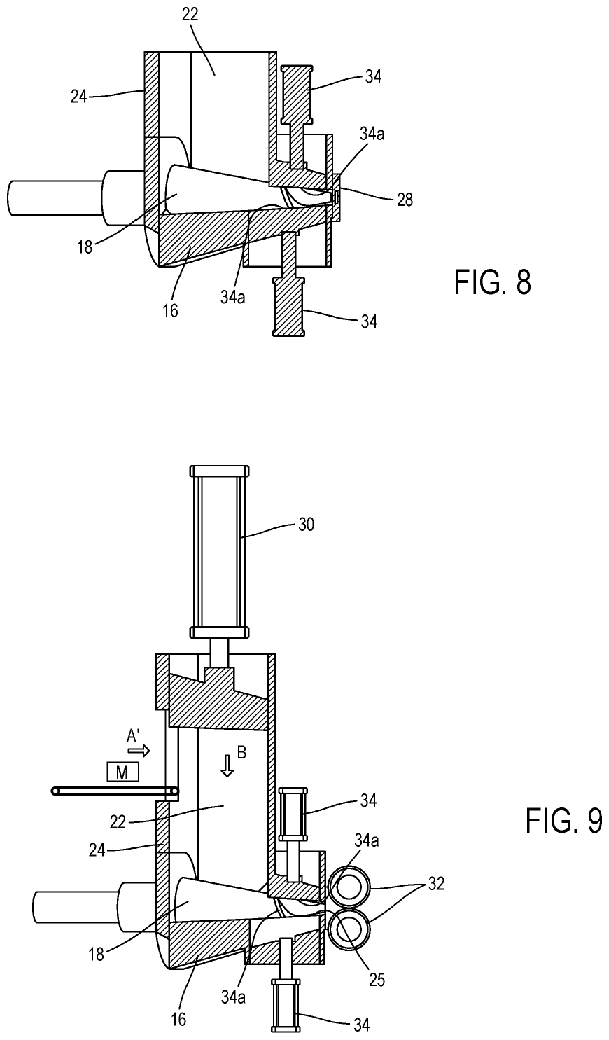

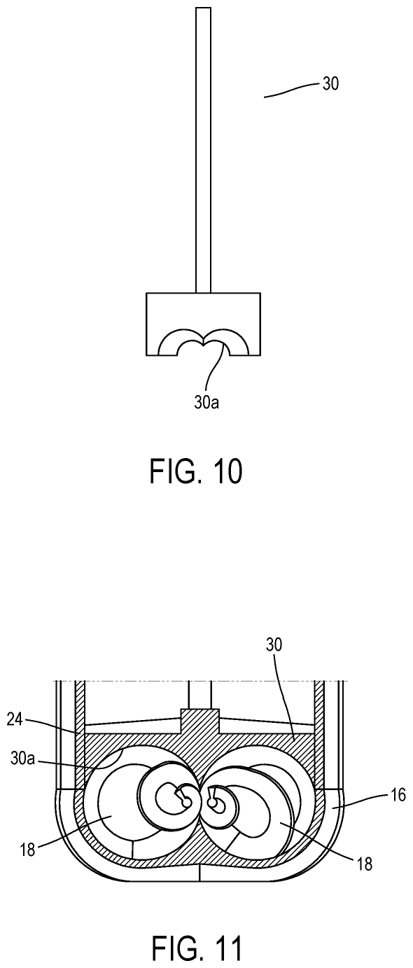

Referring also to FIGS. 9 to 11, another embodiment of the machine 10 includes the two screws 18 and a ram (or equivalent movable presser) 30 that moves inside the introduction hopper 24. This embodiment of the machine 10 can incorporate the mixer 12 having one or more mobile sleeves 34 as described with respect to FIGS. 3 to 8.

The ram 30 is similar to rams used during mixing processes such as those performed by Banbury type internal mixers (disclosed, for example, by patents U.S. Pat. Nos. 1,370,398 and 7,404,664). As with internal mixers, the ram 30 is used to press the mixture and exert pressure on the mixture during production. Thus, the ram 30 allows the transmission of more energy and shear to the mixture and thus improves the working of the rubber.

An inner surface 30a of the ram 30 has a shape that is complementary to an outer contour of the two screws 18. The guidance of the ram 30 is realized between a raised position (represented by FIG. 9), where the two screws 18 remain accessible to introduce the mixture, and a lowered position (represented by FIG. 11), where the inner surface 30a of the ram 30 forms an upper part of the mixer 12. The guidance of the ram 30 is realized by sliding systems as known on Banbury rams (driven, for example, by cylinders that can be pneumatic, hydraulic or their equivalents). Thus, in its lowered position, the ram 30 leaves only a very small clearance between the crests of the screw threads of the screws 18 and its inner surface 30a.

Referring again to FIG. 11 (the two screws are shown in a schematic form), the ram 30 is used to press on the mixture, allowing more energy and shear to be transmitted to the mixture. The ram 30 is also used to clean the surfaces of the introduction hopper 24 during its lowering movement, removing any rubber pieces that may stick to it. At the same time, the ram 30 is also used to improve the consumption of the mixture when it arrives as a “masterbatch” from an upstream machine (the qualities of a “masterbatch” are described below). The ram 30 forces the mixture to pass quickly between the screws 18 and thus prevents it from remaining as a block above the screws.

Referring again to FIG. 9, an embodiment of the machine 10 can include a roller nose system that includes two counter-rotating rollers 32. Some examples of roller nose systems are disclosed by patents FR1563077, FR2282993 and FR3001654. An example of a roller nose system used at the outlet of a converging conical twin-screw extrusion machine is disclosed by patents JP4294005 and U.S. Pat. No. 8,517,714.

A roller nose system of an embodiment of the invention includes two counter-rotating rollers 32 arranged just downstream of the outlet 25 to form a sheet of the mixture emerging from the mixer 12. The roller nose system may also include an optional control means (not shown) to control the feeding speed of the mixture to the rollers. The rotation of the rollers 32 is managed by the amount of the mixture discharged by the mixer 12 (detected, for example, by a proximity sensor, by a pressure sensor or by an equivalent device).

For all embodiments of the machine 10, the screws are chosen from known profiles, including Archimedes screw type screws and profiles known for their self-cleaning nature. Self-cleaning profiles include interpenetrated and conjugated profiles (and particularly interpenetrated co-rotative profiles with conjugated profiles). In other words, for self-cleaning profiles, the screws can be in substantial contact with each other at an angle and at a center distance that will allow self-cleaning. Screws are said to be “substantially in contact” when the screws can be cleaned by friction, or when the two screws face each other with such a small gap between them that an extruded material cannot remain attached to the surfaces of the screws. Screws are said to rub against each other, or to be “self-cleaning”, when the materials transported in the channel of one of the screws cannot remain in that channel for more than one revolution of the screw. As a result, the material undergoes much more movement in the downstream direction, parallel to the screw axis, than in a lateral direction, perpendicular to the axis. Examples of self-cleaning screws are disclosed by patents EP0160124B1, EP0002131B1, U.S. Pat. Nos. 4,300,839, 4,131,371, and 6,022,133 and by publication WO2016/107527.

With reference to FIGS. 1 to 11, a detailed description is given as an example of a cycle of a mixing process of the invention. It is understood that the process can easily be adapted for all the different embodiments of the machine 10.

By initiating a cycle of the mixing process of the invention, the mixing process includes a step of rotating the screws 18 forward with the removable door 28 closed. During this step, the rotating screws cause the product to move downstream of the mixer as soon as the mixture (or raw materials) is introduced into the machine 10. In all embodiments of the machine 10, the rotational speed can be variable during the cycle. When the screws 18 are interpenetrated, the rotational speed of the two screws is synchronized.

The mixing process includes a step of introducing a mixture M into the machine 10 (shown being transported by belt 26 as designated by arrow A in FIG. 2 and by arrow A′ in FIG. 9). During this step, the screws 18 continue to rotate, and the removable door 28 remains closed. In the embodiments of the machine 10 having a ram 30, the ram remains in its raised position during this step. In the embodiments of the machine 10 that also include rollers 32, the rollers remain on standby during this step. The mobile sleeve(s) 34 remain in their open position (that is, with a maximum space between the sleeves and the screws) (see FIG. 4 and FIG. 7).

The step of introducing a mixture into the machine 10 can be executed by introducing into the empty machine the different raw materials necessary for the production of the product, including, without limitation, an elastomeric material (for example, natural rubber, synthetic elastomer and combinations and equivalents thereof) and one or more ingredients, such as one or more processing agents, protective agents and reinforcing charges. Raw materials may also include one or more other ingredients such as carbon black, silica, oils, resins and cross-linking or vulcanization agents. All ingredients are introduced in varying quantities depending on the desired performance of the products obtained from the mixing processes (for example, tires).

The step of introducing a mixture into the machine 10 can also be done by starting the cycle with a product that has already been mixed but does not contain all the ingredients of the recipe (called “masterbatch”). For example, resins and curing agents are not present in the masterbatch. These ingredients, which make mixing difficult, can be added to the mixer 12 to complete mixing. In this case, either the masterbatch is recovered hot from an upstream mixer (such as an internal mixer or an external mixer), or the masterbatch is cold because it has been manufactured and packaged several hours or even several days in advance.

During the mixing cycle, the machine 10 (or a system that incorporates the machine 10) can be trained to recognize values representative of the mixture discharged from the mixer 12 (for example, temperature and viscosity values) and to make a comparison with target values. This machine training includes the recognition of non-equivalences between the compared values. Each step of the training can include a classification generated by self-learning means. This classification may include, without limitation, the parameters of the raw materials and masterbatches of the chosen mixing recipe, the screw configurations (either Archimedes or self-cleaning screws), the process cycle times and the predicted values at the end of a cycle in progress (for example, the value of the space between the sleeves and screws during the current mixing cycle, etc.).

During the step of introducing the mixture into the machine 10, the belt 26 (or another equivalent means) is used to successively introduce the necessary raw materials and other ingredients according to a predetermined recipe. In one embodiment, elastomeric material is introduced into the machine 10, followed by the introduction of reinforcing fillers such as carbon black or silica, oils, resins and vulcanizing agents.

In the embodiments of the machine 10 having a ram 30, the mixing process includes a step of lowering the ram after the step of introducing the mixture M into the machine 10 (see arrow B in FIG. 9). The screws 18 continue to rotate during this step. In embodiments of the machine 10 that also include the rollers 32, the rollers remain on standby during this step.

The mixing process includes a step of partial closure of the mobile sleeve(s) 34. In the embodiments of the mixer with two or more mobile sleeves, the partial closure of the mobile sleeves may refer to their reciprocating movement or to their simultaneous movement. In the embodiments of the machine 10 with a ram 30, the ram remains lowered. During this step, the screws 18 continue to turn.

In embodiments of the machine 10 including a ram 30, the mixing process includes a step of raising the ram. During this step, the mobile sleeve(s) are in a partially closed position. For each embodiment of the machine 10, the screws continue to rotate during this step. In embodiments of the machine 10 including the rollers 32, both rollers remain on standby during this step.

The mixing process includes a step of reversing the screws 10 with the removable door 28 closed. During this step, the screws rotate in a direction opposite to the direction rotation realized during the step of rotating the screws forward. The entire mixture located in machine 10 has a downstream to upstream movement that will cause an additional distribution of raw materials. The mobile sleeve(s) 34 remain partially closed during this step. In embodiments of the machine 10 including a ram 30, the ram remains raised during this step. In the embodiments of the machine 10 including the rollers 32, both rollers remain on standby during this step.

The mixing process includes a step of reversing the screws 10 with the removable door 28 closed. During this step, the screws rotate in the direction opposite to the direction of rotation taken during the step of turning the screws forward. The entire mixture located in the machine 10 has a downstream-upstream movement of the machine that will cause an additional distribution of raw materials. The mobile sleeve(s) 34 remain partially closed during this step. In embodiments of the machine 10 including a ram 30, the ram remains raised during this step. In embodiments of the machine 10 including the rollers 32, both rollers remain on standby during this step.

The mixing process also includes an additional step of rotating the screws 18 forward with the removable door 28 closed. During this step, the screws rotate in the direction opposite to the direction of rotation taken during the step of turning the screws in reverse. The mobile sleeve(s) 34 remain partially closed during this step. In embodiments of the machine 10 including a ram 30, the ram remains raised during this step. In embodiments of the machine 10 including the rollers 32, both rollers remain on standby during this step.

In embodiments of the machine 10 including the ram 30, the mixing process includes a step of lowering the ram that is realized after the preceding step of rotating the screws 18 in reverse. During this step, the screws continue to turn and the mobile sleeve(s) remains partially closed. In embodiments of the machine 10 also having the rollers 32, the rollers remain on standby during this step.

The mixing process includes a step of completely closing the mobile sleeve(s) 34, thus eliminating the gap between the sleeve(s) 34 and the screws 18 (see FIG. 5 and FIG. 8). In embodiments of the mixer 12 having two or more mobile sleeves, this step includes either simultaneous tightening or alternative tightening of the mobile elements. During this step, the screws 18 continue to rotate. In embodiments of the machine 10 with a ram 30, the ram 30 is raised again (as shown in FIG. 9). In embodiments of the machine 10 that also include the rollers 32, the rollers 32 remain on standby.

The mixing process includes a final step of emptying the machine 10. During this step, the movable door 28 opens in order to discharge the mixture from the outlet 25 of the machine toward a downstream process. In embodiments of the machine 10 where the movable door has two or more mobile elements, this step includes either simultaneous opening or alternative opening of the mobile elements. The mobile sleeve(s) 34 remain completely closed, but they can be adjusted according to a volume of the mixture discharged from the mixer. In embodiments of the machine 10 having a ram 30, the ram is lowered during this step. In embodiments of the machine 10 that also include the rollers 32, this step also includes the step of rotating the rollers in order to allow the mixture to be discharged in the form of sheets. In each embodiment of the machine 10, the screws 18 continue to rotate during this step in order to completely empty the machine 10.

At the end of the mixing cycle, the product can be used in a downstream process (which may be, for example, a palletizing process, a shaping process, and/or another mixing process such as an extrusion process). After the end of the step of emptying the machine 10, the mixing process cycle can be restarted.

It is understood that some steps of a mixing cycle, as well as the cycle itself, can be carried out in an iterative manner depending on the selected mixture recipe.

It is also understood that the machine 10 can operate independently or that it may be part of a system or systems that constitute a production plant.

It is envisaged that the machine 10 can carry out one or more processes concerning the plasticization of natural elastomers.

A process cycle can be performed by PLC control and may include pre-programming of control information. For example, a process setting can be associated with the mixture that is supplied to the mixer 12, including the properties of the screws 18, the properties of the mixture entering the introduction hopper 24 and the properties of the mixture exiting the mixer. An adjustment can be, for example, the opening (either partial or total) and closing (partial or total) of the mobile sleeve(s) 34.

For all embodiments of the machine 10, a monitoring system may be put in place. At least part of the monitoring system may be provided in a portable device such as a mobile network device (for example, a mobile phone, a portable computer, a portable device or devices connected to the network, including augmented reality and/or virtual reality devices, portable clothing connected to the network and/or any combinations and/or equivalents).

In some embodiments of the invention, the machine 10 (and/or a system that incorporates the machine 10) may receive voice commands or other audio data representing, for example, a step or stop in the rotation of the screws 18. The request may include a request for the current status of a mixing process cycle. A generated response can be represented in an audible, visual, tactile (for example, using a haptic interface) and/or virtual or augmented manner.

In order to obtain mixtures with the desired properties, the invention preserves all the advantages of a mixer equipped with a converging conical twin-screw mixer. At the same time, the invention combines mobile sleeve solutions to provide a single machine that is capable of processing a variety of mixtures without changing equipment in a mixing facility.

The terms “at least one” and “one or more” are used interchangeably. The ranges that are presented as “between a and b” include the values “a” and “b”.

Although specific embodiments of the disclosed apparatus have been illustrated and described, it is understood that various changes, additions and modifications can be made without departing from the spirit and scope of this disclosure. Therefore, no limitation should be imposed on the scope of the described invention with the exception of those set out in the annexed claims.

1. A mixing and extrusion machine (10) for the production of rubber mixtures, the machine (10) comprising:
a converging conical twin-screw mixer (12) with a fixed frame (14) that supports sleeves (16) in which two screws (18) are mounted at an angle between an opening (22) disposed upstream of the sleeves, where an introduction hopper (24) of the machine (10) feeds the screws, and an outlet (25) disposed downstream of the sleeves, where the mixer (12) discharges the mixture at the end of a mixing cycle, one or more motors (20) that rotate the two screws in the sleeves during the mixing cycle, and one or more movable doors (28) provided at the outlet (25) that allow, during the mixing cycle, the discharge and shaping of a rubber mixture,
wherein at least one mobile sleeve (34) is disposed towards the outlet (25), each mobile sleeve with a support surface (34a) of a predetermined surface area depending on an elasticity of the mixture, and each mobile sleeve comprising one or more mobile elements that move by a linear movement with respect to the outlet (25) in order to adjust a predetermined space between the sleeves (16) and the screws (18), and the linear motion being defined between a closed position of a mobile sleeve to facilitate mixing of the mixture, and an open position of a mobile sleeve to facilitate the flow of the mixture inside the mixer.

2. The machine (10) of claim 1, in which at least two mobile sleeves (34) are arranged towards the outlet.

3. The machine (10) of claim 2, in which the mobile sleeves (34) are arranged top-down towards the outlet.

4. The machine (10) of claim 3, wherein the linear movement of the mobile sleeves (34) is selected from simultaneous movement, reciprocating movement and random movement of the mobile elements.

5. The machine (10) of claim 2, further comprising a ram (30) with an inner surface (30a) having a shape that is complementary to an outer contour of the two screws (18), the ram moving inside the introduction hopper (24) between a raised position, where the two screws remain accessible for introducing the mixture, and a lowered position, where the inner surface (30a) of the ram forms an upper part of the mixer (12).

6. The machine (10) of claim 5, further comprising a roller nose system comprising two counter-rotating rollers (32) arranged just downstream of the outlet (25) to form a sheet of the mixture discharged from the mixer (12).

7. The machine (10) of claim 1, wherein the screws (18) are mounted in the mixer (12) so that the threads of each screw contact tangentially the surfaces of the opposite screw so that the screws remain substantially in contact with each other when rotating the screws at an angle and at a center distance that facilitates self-cleaning.

8. The machine (10) of claim 7, wherein the screws (18) are selected from interpenetrated and conjugated profiles, including interpenetrated co-rotative profiles with conjugated profiles.

9. A mixing process of the type comprising a step of mixing and extruding a mixture from a machine (10) of claim 1, the process comprising the following steps:
a step of rotating the screws (18) forward with the movable door (28) closed;
a step of introducing the mixture to the machine (10), during which the screws (18) continue to rotate and the movable door (28) remains closed; and
a step of emptying the machine (10), during which the movable door opens to let the mixture out of the machine outlet (25) toward a downstream process, and during which the screws continue to rotate until the mixer is empty.

10. The process of claim 9, in which the step of introducing the mixture to the machine (10) comprises introducing the raw materials to form the mixture.

11. The process of claim 9, in which the step of introducing the mixture to the machine (10) includes the introduction of one or more masterbatches.

12. The process of claim 9, in which:
the movable door (28) is in the closed position at the beginning of the mixing cycle and in the open position at the end of the mixing cycle; and
each mobile sleeve (34) is in the open position at the beginning of the mixing cycle and in the closed position at the end of the mixing cycle.
